(19) United States
(12) Patent Application Publication
(10) Pub. No.: US 2007/0064975 A1
(43) Pub. Date: Mar. 22, 2007

(54) Moving object measuring apparatus, moving object measuring system, and moving object measurement

(75) Inventors: Kenta Takanohashi, Nara (JP); Yoshitsugu Manabe, Nara (JP); Yoshihiro Yasumuro, Nara (JP); Kunihiro Chihara, Nara (JP)

Correspondence Address: RADER FISHMAN & GRAUER PLLC, LION BUILDING, 1233 20TH STREET N.W., SUITE 501, WASHINGTON, DC, 20036, US

(73) Assignee: National University Corporation Nara Institute of Science and Technology, Nara (JP)

(21) Appl. No.: 11/433,401

(22) Filed: May 15, 2006

(30) Foreign Application Priority Data
Sep. 22, 2005 (JP) 2005-275084

(51) Int. Cl. G06K 9/00

(52) U.S. Cl. 382/103; 382/107

(57) ABSTRACT

A moving object measuring apparatus includes: a movement trajectory information acquisition portion that obtains movement trajectory information indicating a movement trajectory of a moving object from images included in two or more video sequences that are stored, for each of the two or more video sequences separately; a three-dimensional trajectory information acquisition portion that obtains three-dimensional trajectory information that is information of a three-dimensional trajectory of the moving object by using Visual Hulls Method, based on the movement trajectory information obtained by the movement trajectory information acquisition portion for each of the two or more video sequences separately and two or more camera parameters that are stored; and a three-dimensional trajectory information output portion that outputs the three-dimensional trajectory information.

### BACKGROUND OF THE INVENTION

1. Field of the Invention

The present invention relates to a moving object measuring apparatus or the like that obtains the three-dimensional movement trajectory of an object that moves at high speed, such as a ball in a ball sport, from images taken with plural cameras.

2. Description of Related Art

The first conventional technology is a configuration in which images taken with unidirectional cameras are processed by an image processing unit. This image processing unit is a moving object measuring apparatus configured to carry out, in a single cycle, image input, detection processing of a player and a ball, identification processing of the ball, tracking processing of the player and the ball, coordinate transformation processing, detection processing of contact between the ball and the ground, correction of the ball coordinates, measurement processing of the ball height, and extraction processing of the trajectories of the player and the ball (see JP2001-273500A (e.g., page 1 and FIG. 1)). This moving object measuring apparatus detects the player and the ball, while distinguishing between them, by executing the detection processing of the player and the ball and the identification processing of the ball, and determines the player coordinates and the ball coordinates on the camera coordinates by the tracking processing of the player and the ball. The coordinate sequences of the player and the ball that are measured every moment become their respective camera trajectories. Then, this moving object measuring apparatus transforms each of the player trajectory and the ball trajectory into a trajectory in world coordinates by the coordinate transformation processing. Since the player is substantially in contact with the ground surface, the above-described trajectory in world coordinates is directly used as a desired player trajectory. On the other hand, the ball is not always in contact with the ground, so that the ball trajectory is not a desired ball trajectory. Therefore, the moving object measuring apparatus determines the world coordinates of positions at which the ball comes in contact with the ground surface by the detection processing of contact between the ball and the ground, connects at least two of the positions at which the ball comes in contact with the ground with a straight line or a model curve, and uses this as the ball trajectory on the ground surface in place of the above-mentioned ball trajectory in world coordinates. Then, the moving object measuring apparatus calculates the height of the ball by the measurement processing of the ball height using the world coordinates before correction and the world coordinates after correction. The moving object measuring apparatus adds the ball height to the corrected ball trajectory in world coordinates, thereby obtaining a three-dimensional trajectory in world coordinates.

The second conventional technology is high speed, three-dimensional position estimation of a moving object using a difference in shutter timing between cameras (see, Shoichi Shimizu, “Fast 3D Position Measurement Using Cameras Shutter Timing Adjusted”, 2004, MIRU2004, vol. 1, pp. 428-433). This technology is aimed at improving the apparent measurement rate using plural cameras with a normal measurement rate.

Additionally, the related conventional technology includes a technique called Visual Hulls Method in which plural silhouette images obtained by extracting object areas from images of an object are projected to the original three-dimensional space, and three-dimensional shape data (a set of voxel data) of the object is obtained by determining the intersection of the visual volumes (see for example, Laurentini, A. “The visual hull concept for silhouette-based image understanding”, 1994, IEEE, PAMI, Vol. 16, pp. 150-162). In addition, we have a case called volume intersection method for Visual Hulls Method.

However, since the first conventional technology is a method in which the world coordinates of the positions at which the ball comes in contact with the ground is obtained by the detection processing of contact between the ball and the ground, using unidirectional cameras, and then the three-dimensional ball trajectory is obtained by performing the measurement processing of the ball height, the detection processing of contact between the ball and the ground is performed in this method. Therefore, there has been a problem in that it is not possible to obtain a trajectory if the ball does not come in contact with the ground.

In the second conventional technology, it is necessary to first determine a trajectory in which images of a target object are connected by an interpolation technique or the like for successive frames of video sequences taken with a single camera, before integrating information from plural cameras. Therefore, there is the possibility that a trajectory may not be obtained accurately, for example, when a moving object moves discontinuously. For example, with the second conventional technology, it has been difficult to accurately obtain the trajectory of a ball for which no image has been captured at a moment when it is kicked or bounces.

### SUMMARY OF THE INVENTION

A first aspect of the present invention is directed to a moving object measuring apparatus including: a video information storage portion storing two or more video sequences that are two or more pieces of video information captured with at least two cameras placed at different positions in a space for capturing, at overlapping times, images of a moving object that moves in the space, the two or more video sequences including a plurality of two-dimensional images in which a movement trajectory of the moving object is retained; a camera parameter storage portion storing two or more camera parameters that are pieces of information relating to the two or more cameras; a movement trajectory information acquisition portion that obtains movement trajectory information indicating a movement trajectory of the moving object from images included in the two or more video sequences stored in the video information storage portion, for each of the two or more video sequences separately; a three-dimensional trajectory information acquisition portion that obtains three-dimensional trajectory information that is a three-dimensional trajectory of the moving object by using Visual Hulls Method, based on the movement trajectory information obtained by the movement trajectory information acquisition portion for each of the two or more video sequences separately and the two or more camera parameters stored in the camera parameter storage portion; and a three-dimensional trajectory information output portion that outputs the three-dimensional trajectory information.

In a moving object measuring apparatus according to a second aspect of the present invention based on the first aspect, it is preferable that the two or more video sequences in the video information storage portion are pieces of video information captured with two or more unsynchronized cameras, and include a plurality of images in which a movement trajectory of the moving object is retained.

In a moving object measuring apparatus according to a third aspect of the present invention based on the first aspect, the movement trajectory information acquisition portion extracts two or more pieces of movement trajectory information indicating a movement trajectory of the moving object from two or more images included in the two or more video sequences stored in the video information storage portion and combines the two or more pieces of movement trajectory information, thereby obtaining modified movement trajectory information corresponding to each of the video sequences.

In a moving object measuring apparatus according to a fourth aspect of the present invention based on the first aspect, the movement trajectory information acquisition portion obtains movement trajectory information indicating a movement trajectory of the moving object from single images included in the two or more video sequences stored in the video information storage portion, for each of the video sequences separately.

With such a configuration, it is possible to readily obtain the three-dimensional trajectory of a moving object with a camera having a shutter speed that is not high, by utilizing the trajectory of a moving object in single images.

In a moving object measuring apparatus according to a fifth aspect of the present invention based on any of the first to fifth aspects, the video information is video information captured with a camera with 30 frames/sec.

With such a configuration, it is possible to readily obtain the three-dimensional trajectory of a moving object with commercially available video cameras.

In a moving object measuring apparatus according to a sixth aspect of the present invention based on any of the first to fifth aspects, the moving object is a spherical object.

With such a configuration, it is possible to use the moving object measuring apparatus, for example, as an authoring system used for ball sports broadcasting and an authoring system for creating the content of a game or the like.

A seventh aspect of the present invention is directed to a moving object measuring apparatus that obtains three-dimensional trajectory information that is information of a three-dimensional trajectory of a moving object by using Visual Hulls Method, based on movement trajectory information that is information indicating a movement trajectory of the moving object in images included in two or more video sequences that are two or more pieces of video information captured with two or more cameras placed at different positions in a space for capturing, at overlapping times, images of a moving object that moves in the space, the two or more video sequences including a plurality of images in which a movement trajectory of the moving object is retained, and outputs the three-dimensional trajectory information.

An eighth aspect, of the present invention is directed to a moving object measuring system including: two or more cameras that are placed at different positions in a space for capturing images of a moving object that moves in the space; and the moving object measuring apparatus according to the first aspect.

In a moving object measuring apparatus according to a ninth aspect of the present invention based on the eighth aspect, the two or more cameras include a video information transmitting unit that transmits captured video information, the moving object measuring apparatus further includes a video information receiving portion that receives two or more pieces of video information from the two or more cameras, and the two or more video sequences in the video information storage portion are the two or more pieces of video information received by the video information receiving portion.

With such a configuration, it is possible, for example, to immediately provide the three-dimensional trajectory of the ball to viewers, while broadcasting a ball sport.

With the moving object measuring apparatus according to the present invention, a three-dimensional trajectory of a moving object can be readily obtained.

### BRIEF DESCRIPTION OF THE DRAWINGS

FIG. 1 is a conceptual diagram showing a moving object measuring system according to Embodiment 1.

FIG. 2 is a block diagram showing the moving object measuring system.

FIG. 3 is a flowchart illustrating the operation of a moving object measuring apparatus according to the same embodiment.

FIG. 4 is a diagram showing an example of an image-taking site of the moving object measuring system.

FIGS. 5A1-5C2 are explanatory diagram showing movement trajectory information obtained by the moving object measuring apparatus.

FIG. 6 is a diagram showing movement trajectory information that is obtained by the moving object measuring apparatus by combination.

FIGS. 7A-7C are explanatory diagram showing movement trajectory information that is obtained by the moving object measuring apparatus by combination.

FIG. 8 is a diagram showing a three-dimensional trajectory information management table of the moving object measuring apparatus.

FIG. 9 is a diagram showing an example of three-dimensional trajectory information that is output by the moving object measuring apparatus.

FIGS. 10A and 10B are explanatory diagram illustrating the concept of the process of the moving object measuring apparatus.

FIG. 11 is a diagram illustrating the concept of the process of the moving object measuring apparatus.

FIG. 12 is a block diagram showing a moving object measuring system according to Embodiment 2.

FIG. 13 is a flowchart illustrating the operation of a moving object measuring apparatus according to the same embodiment.

### DETAILED DESCRIPTION OF THE INVENTION

Embodiments of the moving object measuring apparatus and the like according to the present invention are described below with reference to the accompanying drawings. It should be noted that components that are denoted by the same reference numerals in the embodiments perform the same operation, and therefore may not be described in duplicate.

### Embodiment 1

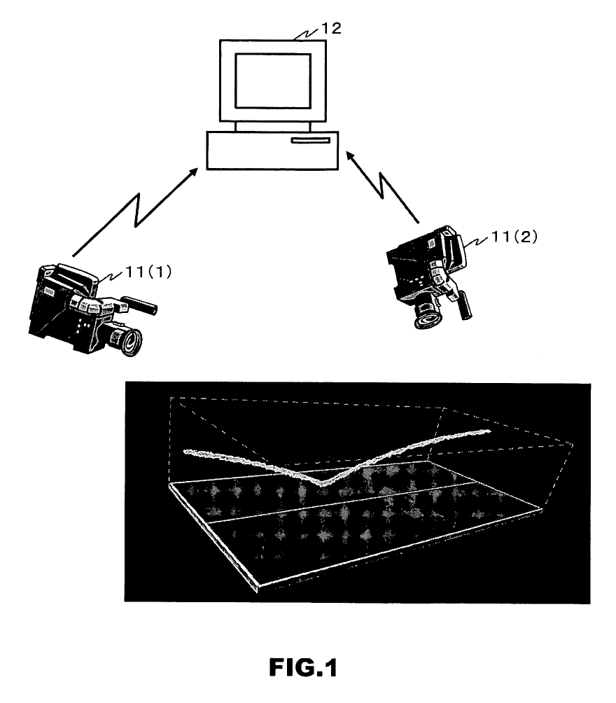

FIG. 1 is a conceptual diagram of a moving object measuring system according to this embodiment. The moving object measuring system includes two or more cameras 11 (in this example, two cameras, namely, a camera 11(1) and a camera 11(2)) and a moving object measuring apparatus 12.

The cameras 11 include a video information transmitting unit 111 that transmits captured video information to the moving object measuring apparatus 12. The video information transmitting unit 111 may be implemented with a wireless or wired communications unit. However, the video information transmitting unit 111 may also be implemented with a broadcasting unit.

In the moving object measuring system, the cameras 11 are two or more cameras placed at different positions in a space for taking images of a moving object that moves in that space. In addition, it is preferable that the cameras 11 are cameras with a slow shutter speed. For example, the video information taken and captured with the cameras 11 may be a set of still images that is video information taken at 30 frames/sec. It is not necessary to synchronize the two or more cameras.

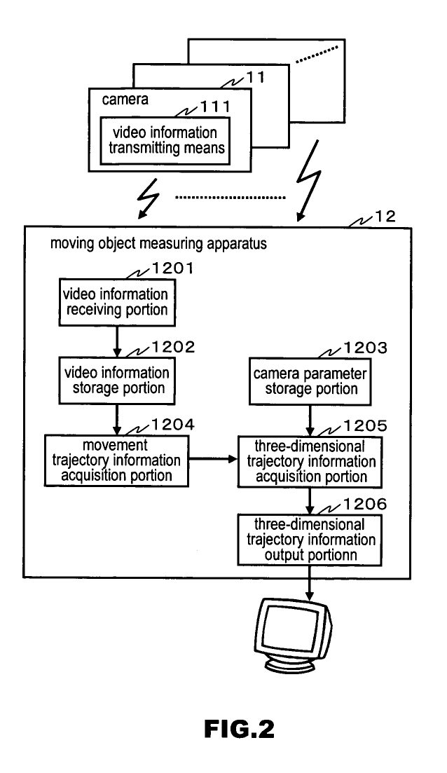

FIG. 2 is a block diagram showing a moving object measuring system according to this embodiment.

The cameras 11 include a video information transmitting unit 111.

The moving object measuring apparatus 12 includes a video information receiving portion 1201, a video information storage portion 1202, a camera parameter storage portion 1203, a movement trajectory information acquisition portion 1204, a three-dimensional trajectory information acquisition portion 1205 and a three-dimensional trajectory information output portion 1206.

The video information receiving portion 1201 receives video information from two or more cameras 11. The video information receiving portion 1201 may be implemented with a wireless or wired communications unit. However, the video information receiving portion 1201 may also be implemented with a unit that receives broadcast (e.g., a tuner).

In the video information storage portion 1202, two or more video sequences are stored. The two or more video sequences are pieces of video information captured with the two or more cameras 11. For example, they are pieces of video information received by the video information receiving portion 1201. The cameras 11 are cameras that are placed at different positions in a space for capturing images of a moving object that moves in that space. Further, the two or more video sequences are two or more pieces of video information captured with two or more cameras that capture images of the moving object at overlapping times, and include a plurality of two-dimensional images (still images) in which the movement trajectory of the moving object is retained. The two or more cameras 11 are not in frame synchronization. Preferably, the video information storage portion 1202 may be a nonvolatile recording medium, but it may also be implemented as a volatile recording medium. It should be noted that the moving object may be a ball used in a sport such as table tennis, baseball, soccer or golf, or a different moving object. Generally, the moving object has a color that is different from the background color. The video information storage portion 1202 may be physically formed by two or more recording media. Further, the above-described video information stored in the video information storage portion 1202 may be obtained from the cameras 11 via a recording medium or the like, and is not limited to the video information received by the video information receiving portion 1201.

In the camera parameter storage portion 1203, two or more camera parameters are stored that are pieces of information relating to two or more cameras. The term “camera parameter” refers to geometric information relating to a camera. The geometric information relating to a camera includes information such as the camera position, the orientation, the focal length, the image center, and the image distortion due to the lens. Typically, the camera position information is (x, y, z), which is information representing coordinates in a space, (longitude, latitude) or the like. The camera parameters stored in the camera parameter storage portion 1203 may be received from the cameras 11 or the like by a receiving portion (not shown). The camera parameter storage portion 1203 may be either a nonvolatile recording medium or a volatile recording medium.

The movement trajectory information acquisition portion 1204 obtains movement trajectory information indicating a movement trajectory of the moving object, from images included in the two or more video sequences stored in the video information storage portion 1202, for each of the two or more video sequences separately. One example of the algorithm for obtaining the movement trajectory information from the images is background subtraction. Since background subtraction is a known technique, the description is omitted. Another example of the algorithm for obtaining the movement trajectory information from the images is a process of extracting only dots with the same or similar color to the color of the moving object from the images. In this case, it is necessary that the color of the moving object and the color of the background are sufficiently different. For example, the movement trajectory information acquisition portion 1204 may extract two or more pieces of movement trajectory information (short movement trajectory information) indicating the movement trajectory of the moving object from the two or more images included in two or more video sequences (a set of still images) stored in the video information storage portion 1202, and combine the two or more pieces of movement trajectory information, thereby obtaining movement trajectory information (long movement trajectory information in which pieces of short movement trajectory information are connected) corresponding to each of the video sequences. In this case, the movement trajectory information acquisition portion 1204 obtains a number of pieces of movement trajectory information that corresponds to the number of the cameras 11. Furthermore, the movement trajectory information obtained by the movement trajectory information acquisition portion 1204 is information indicating the trajectory of the moving object. It should be noted that when the cameras include a shutter, the movement trajectory information is information of a trajectory wherein no movement is depicted while the shutters of the cameras are closed. Typically, the movement trajectory information is a set of information of (x, y) or (x, y, col). Here, “col” denotes color information. Typically, the movement trajectory information acquisition portion 1204 may be implemented with an MPU, a memory or the like. The processing procedure of the movement trajectory information acquisition portion 1204 may be typically implemented with software, which is recorded in a recording medium such as a ROM. However, it may also be implemented with hardware (a dedicated circuit).

Based on the movement trajectory information obtained by the movement trajectory information acquisition portion 1204 for each of the two or more video sequences separately and the two or more camera parameters stored in the camera parameter storage portion 1203, the three-dimensional trajectory information acquisition portion 1205 obtains three-dimensional trajectory information that is information of the three-dimensional trajectory of a moving object by using Visual Hulls Method. Since the Visual Hulls Method is a known technique, its description is omitted. Further, the three-dimensional trajectory information acquisition portion 1205 may use Visual Hulls Method with any algorithm from among the several existing Visual Hulls Methods to obtain the three-dimensional trajectory information. Further, the three-dimensional trajectory information is typically voxel information (x, y, z, col). That is to say, the three-dimensional trajectory information typically includes position information in the space and color information. However, the three-dimensional trajectory information may only include position information in a space (x, y, z). Typically, the three-dimensional trajectory information acquisition portion 1205 may be implemented with an MPU, a memory or the like. The processing procedure of the three-dimensional trajectory information acquisition portion 1205 may be typically implemented with software, which is recorded in a recording medium such as a ROM. However, it may also be implemented with hardware (a dedicated circuit).

The three-dimensional trajectory information output portion 1206 outputs the three-dimensional trajectory information obtained by the three-dimensional trajectory information acquisition portion 1205. Here, “output” is a concept that encompasses output to a display, printing to a printer, transmission to an external apparatus, storage on a recording medium, for example. The three-dimensional trajectory information output portion 1206 may or may not be considered to include an output device such as a display. The three-dimensional trajectory information output portion 1206 may be implemented, for example, with driver software of an output device, or a combination of driver software of an output device and the output device.

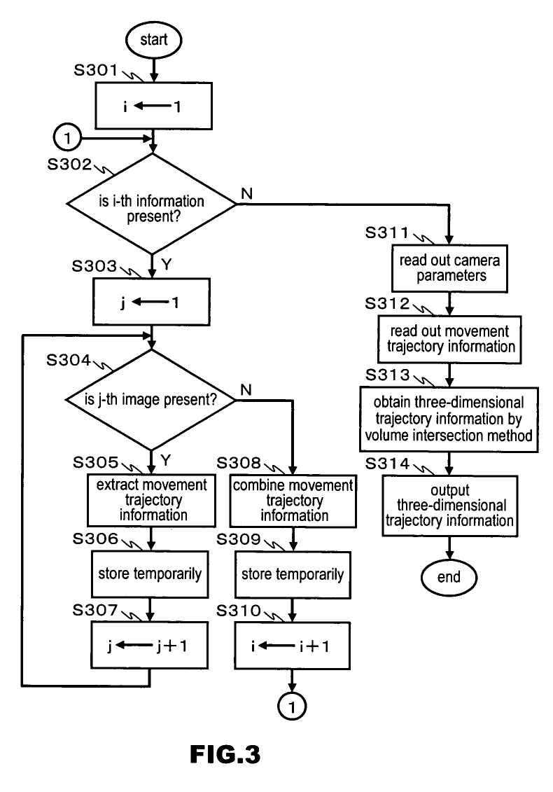

Next, the operation of the moving object measuring apparatus is described with reference to the flowchart of FIG. 3. It should be noted that in the flowchart of FIG. 3, the video information receiving portion 1201 receives two or more pieces of video information from the two or more cameras 11, and the received two or more pieces of video information are stored in the video information storage portion 1202.

(Step S301) The movement trajectory information acquisition portion 1204 assigns 1 to a counter i.

(Step S302) The movement trajectory information acquisition portion 1204 judges whether the i-th video information is stored in the video information storage portion 1202. The i-th video information is video information captured with the i-th camera 11. If the i-th video information is stored, then the procedure advances to Step S303. If the i-th video information is not stored, then the procedure advances to Step S311.

(Step S303) The movement trajectory information acquisition portion 1204 assigns 1 to a counter j.

(Step S304) The movement trajectory information acquisition portion 1204 judges whether the j-th image (still mage) is present in the i-th video information. If the j-th image is present, then the procedure advances to Step S305. If the j-th image is not present, then the procedure advances to Step S308.

(Step S305) The movement trajectory information acquisition portion 1204 extracts the movement trajectory information from the j-th image. For example, based on the color of the moving object, the movement trajectory information acquisition portion 1204 obtains a set of dots with that color “(x, y) or (x, y, col)” from the j-th image (bitmap information). The movement trajectory information acquisition portion 1204 extracts the movement trajectory information by background subtraction, for example. Here, the cameras 11 have a sufficiently slow shutter speed. Since the moving speed of the moving object is typically high, the trajectory of the moving object is depicted in the j-th image. “The trajectory of the moving object” is typically a set of dots.

(Step S306) The movement trajectory information acquisition portion 1204 temporarily stores, in a memory or the like, the movement trajectory information obtained at Step S305.

(Step S307) The movement trajectory information acquisition portion 1204 increments the counter j by 1. Then, the procedure returns to Step S304.

(Step S308) The movement trajectory information acquisition portion 1204 reads out the two or more pieces of the movement trajectory information temporarily stored in a memory or the like at Step S306, and combines them. The combining process may be carried out simply by connecting these pieces of movement trajectory information. It should be noted that the information obtained by the combining process at Step S308 is the movement trajectory information for each of the cameras.

(Step S309) The movement trajectory information acquisition portion 1204 temporarily stores, in a memory or the like, the movement trajectory information for each of the cameras that has been obtained at Step S308.

(Step S310) The movement trajectory information acquisition portion 1204 increments the counter i by 1. Then, the procedure returns to Step S302.

(Step S311) The three-dimensional trajectory information acquisition portion 1205 reads out the two or more camera parameters stored in the camera parameter storage portion 1203.

(Step S312) The three-dimensional trajectory information acquisition portion 1205 reads out the two or more pieces of movement trajectory information temporarily stored in a memory or the like at Step S309.

(Step S313) Based on the two or more camera parameters read out at Step S311 and the movement trajectory information read out at Step S312, the three-dimensional trajectory information acquisition portion 1205 obtains three-dimensional trajectory information that is information of the three-dimensional trajectory of the moving object by using Visual Hulls Method. The dot information constituting the three-dimensional trajectory information may or may not include color information.

(Step S314) The three-dimensional trajectory information output portion 1206 outputs the three-dimensional trajectory information obtained at Step S313. It should be noted that the three-dimensional trajectory information output portion 1206 may output the three-dimensional trajectory information after combining it with video of an object other than the moving object. Typically, the video of an object other than moving object has been previously stored.

The specific operation of the moving object measuring apparatus according to this embodiment is described below. A conceptual diagram of the moving object measuring system is shown in FIG. 1.

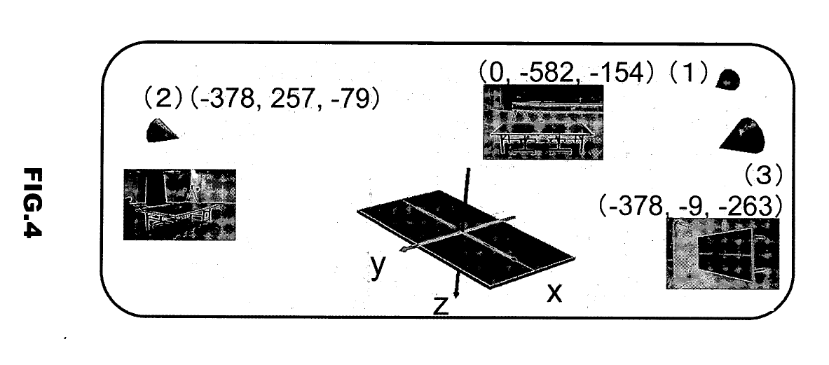

Now, as shown in FIG. 4, the trajectory of a moving table-tennis ball is output using a moving object measuring system. That is, high-speed movements of the table-tennis ball are measured using the moving object measuring system.

The moving object measuring system of this embodiment includes three cameras 11 and a moving object measuring apparatus 12. In FIG. 4, the three cameras 11 are denoted by conical shapes. The three cameras 11 are placed at the positions: (1) (0, −582, −154), (2) (−378, 257, −79), and (3) (−378, −9, −263). It should be noted that the coordinate system of the X-axis, the Y-axis and the Z-axis is as shown in FIG. 4, wherein the center of the table-tennis table is the point of origin (0, 0, 0). The camera of (1) is placed at a right angle to the side of the table-tennis table, the camera of (2) is placed obliquely to the side of the table-tennis table, and the camera of (3) is placed on the ceiling above the table-tennis table. In addition, the three cameras 11 are commercially available home video cameras whose shutter speed is set to 1/30s, which is the same as the image-taking rate. Further, the size of images captured with the three cameras 11 is set to “720×480 (pixel)”.

Now, let us assume that the movements of the ball are captured by the three cameras 11 when players play table tennis. Here, the captured images are stored in a recording medium (e.g., a hard disk or a magnetic tape). Additionally, the image-taking range of the cameras 11 is set to the range of the table-tennis table (274 cm×152 cm×60 cm).

Next, from the recording medium in which the video information that has been captured with the three cameras is recorded, the user copies the video information in the video information storage portion 1202 of the moving object measuring apparatus 12.

Further, the user writes camera parameters such as the camera position information ((1) (0, −582, −154), (2) (−378, 257, −79), and (3) (−378, −9, 263)), the orientation, the focal length, the image center and the image distortion due to the lens onto the camera parameter storage portion 1203.

Next, the user gives an instruction to output the three-dimensional trajectory information (the trajectory of the moving table-tennis ball). This instruction is given, for example, by pressing a start button included in the moving object measuring apparatus 12.

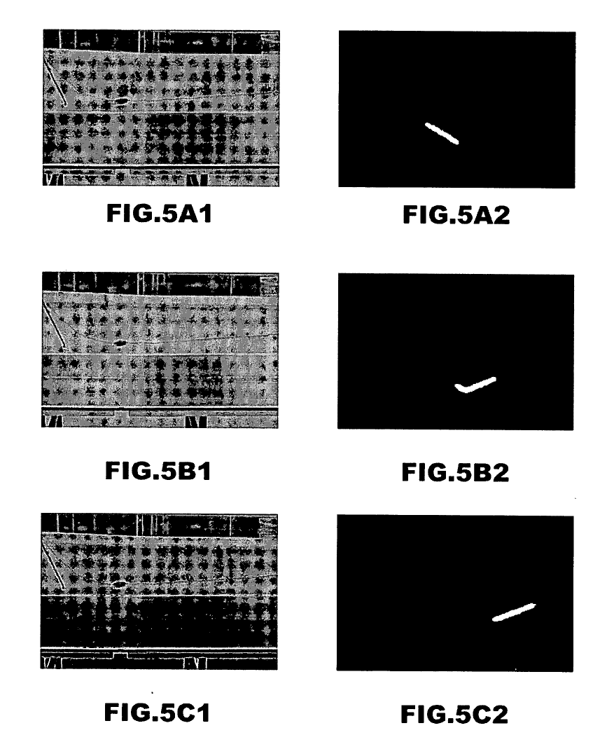

Next, the movement trajectory information acquisition portion 1204 obtains images from the first video information in the video information storage portion 1202, and obtains the movement trajectory information by background subtraction. That is, the movement trajectory information acquisition portion 1204 obtains ball movement trajectory information (a2) (a set of dots) from the images from image (a1) in FIG. 5. Similarly, the movement trajectory information acquisition portion 1204 obtains ball movement trajectory information (b2) from image (b1) in FIG. 5. Further, the movement trajectory information acquisition portion 1204 similarly obtains ball movement trajectory information (c2) from image (c1) in FIG. 5.

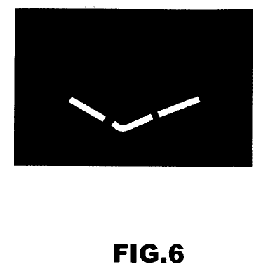

Next, the movement trajectory information acquisition portion 1204 combines the pieces of ball movement trajectory information ((a2), (b2), (c2) etc. in FIG. 5), thereby obtaining the ball movement trajectory information shown in FIG. 6. The ball movement trajectory information of FIG. 6 is movement trajectory information obtained by combining two or more pieces of movement trajectory information extracted from images (still images).

Next, the movement trajectory information acquisition portion 1204 obtains ball movement trajectory information from the second video information and the third video information in the same manner (as with the first video information).

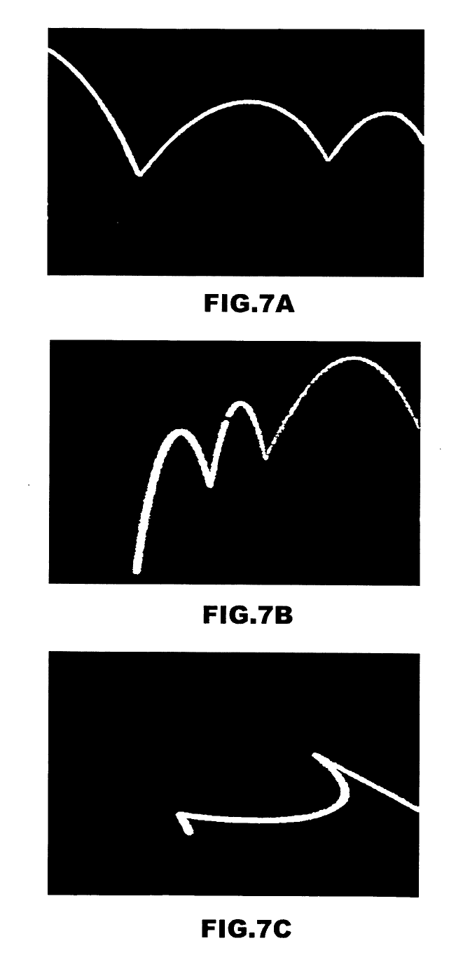

Here, the movement trajectory information acquisition portion 1204 obtains the three pieces of movement trajectory information: (a), (b) and (c) in FIG. 7, for example. (It should be noted that the figure in FIG. 6 and the figures in FIG. 7 do not show trajectories of the same ball.)

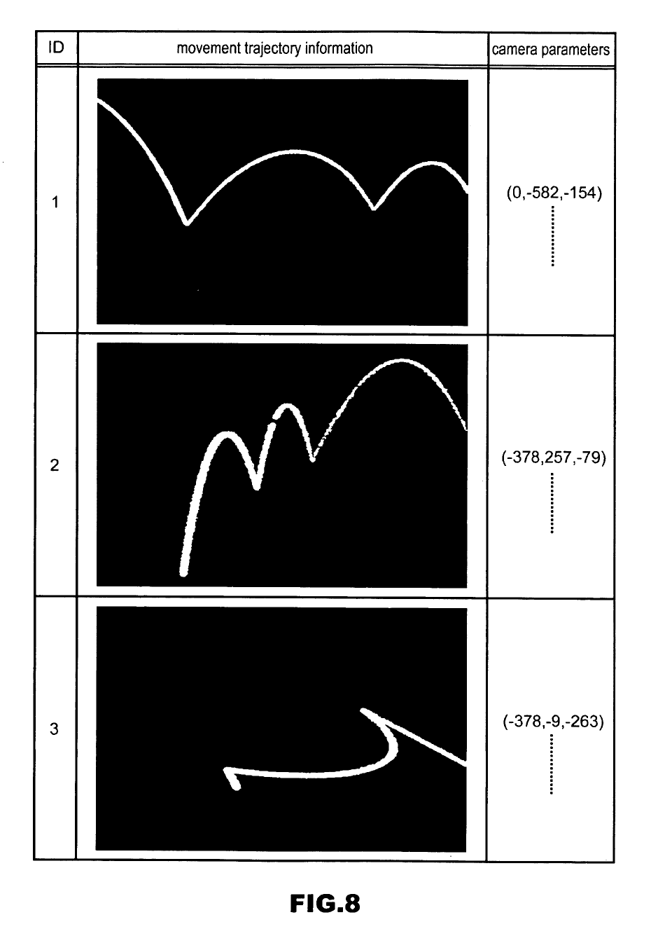

Next, the three-dimensional trajectory information acquisition portion 1205 reads out the three pieces of movement trajectory information ((a), (b) and (c) in FIG. 7) and three camera parameters stored in the camera parameter storage portion 1203. Then, the three-dimensional trajectory information acquisition portion 1205 obtains the information (three-dimensional trajectory information management table) shown in FIG. 8.

Next, the three-dimensional trajectory information acquisition portion 1205 obtains three-dimensional trajectory information that is information of the three-dimensional trajectory of the moving object by using Visual Hulls Method, for the information shown in FIG. 8. Typically, the three-dimensional trajectory information is a set of voxel information.

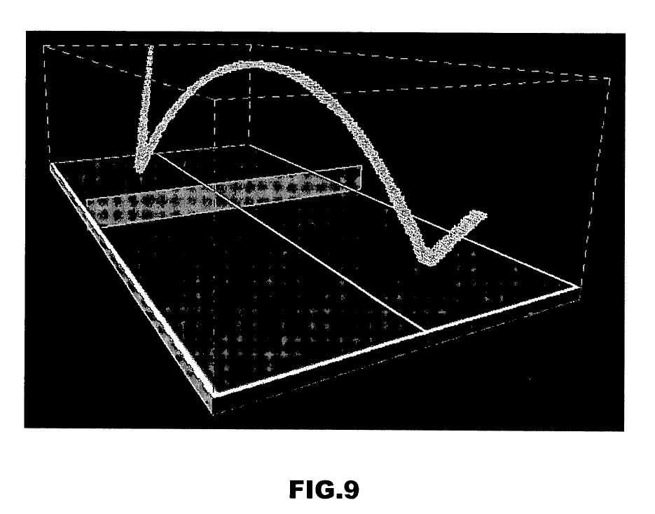

Next, the three-dimensional trajectory information output portion 1206 outputs the three-dimensional trajectory information obtained by the three-dimensional trajectory information acquisition portion 1205. An example of the three-dimensional trajectory information output by the three-dimensional trajectory information output portion 1206 is shown in FIG. 9. In the example shown in FIG. 9, the three-dimensional trajectory information output portion 1206 outputs the obtained three-dimensional trajectory information after combining it with an image of the table-tennis table, which is the background. In addition, the size of a single voxel is 1 cm³.

As descried above, according to this embodiment, it is possible to readily measure the three-dimensional trajectory of a moving object (e.g., a ball). Moreover, it is also possible to determine a point at which a moving object has bounced. Particularly, it is possible to measure the three-dimensional trajectory of a ball by simply placing several commonly used cameras whose shutter speeds are not high. Furthermore, it is not necessary to synchronize the shutters of the cameras, so that it is possible to readily measure the three-dimensional trajectory of a moving object. That is, a plurality of cameras takes images of a moving object without being synchronized. Then, two or more video sequences including a plurality of images in which the movement trajectory of the moving object is retained are obtained. The moving object measuring apparatus of this embodiment uses these two or more video sequences to obtain the three-dimensional trajectory of the moving object.

Although the moving object is a table-tennis ball in this embodiment, it also may be a tennis ball, a golf ball, or a living thing such as a bird. This also applies to the other embodiment.

In the specific example of this embodiment, the moving object measuring apparatus 12 obtains the video information from the cameras 11 via the recording medium. However, the moving object measuring apparatus 12 may receive the video information from the cameras 11. In this case, it is possible to view the three-dimensional trajectory of the ball with a small time difference, while watching a table-tennis match. This also applies to the other embodiment.

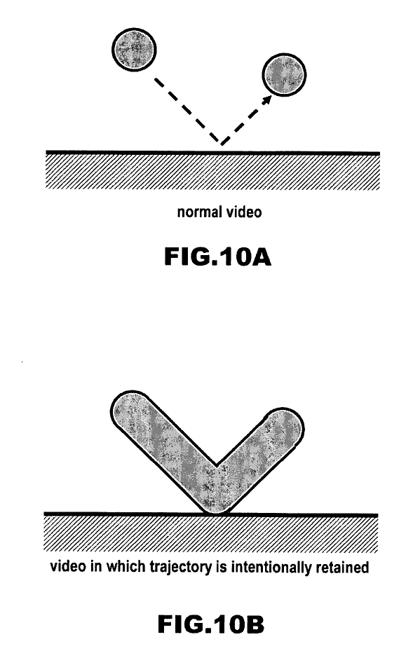

Furthermore, the moving object measuring apparatus of this embodiment obtains three-dimensional trajectory information that is information of the three-dimensional trajectory information of the moving object, using video as shown in FIG. 10B that has been taken with a camera with a slow shutter speed so that the trajectory is intentionally retained, instead of using normal video as shown in FIG. 10A. The speed of a pitched baseball is about 150 km/h, i.e., about 40 m/sec, so that the ball moves about 1.3 m in a single frame when sampling is performed at 30 frames/sec. The speed of a golf ball in the case of a driver shot is about 80 m/sec, so that the ball moves about 2.6 m in a single frame when sampling is performed at 30 frames/sec. The speed of a served tennis ball is about 200 km/h, i.e., about 55 m/sec, so that the ball moves about 1.8 m in a single frame when sampling is performed at 30 frames/sec.

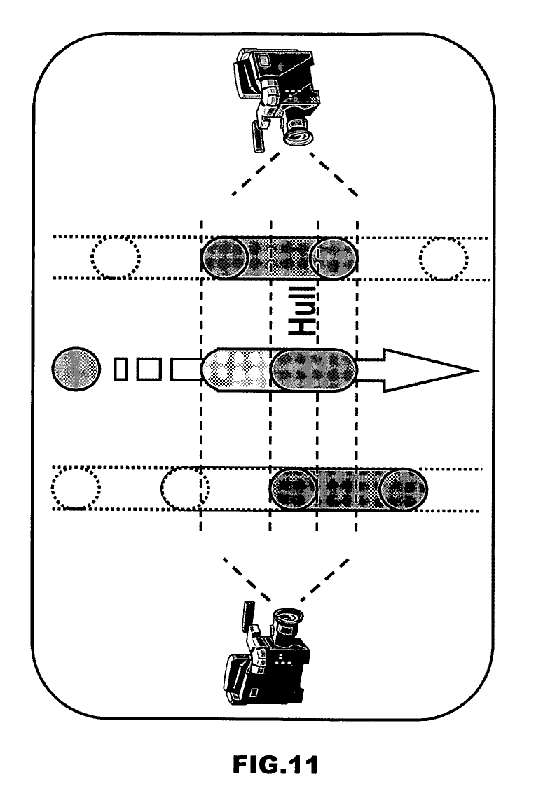

Furthermore, as shown in FIG. 11, the moving object measuring apparatus of this embodiment obtains three-dimensional trajectory information that is information of the three-dimensional trajectory information of a moving object by using Visual Hulls Method, using two or more pieces of video information captured with two or more cameras capturing images of the moving object at overlapping times. Therefore, it is not necessary to synchronize the cameras.

Moreover, the processing in this embodiment may also be implemented with software. This software may be distributed by way of a software download or the like. Furthermore, such software may be disseminated by being recorded in a recording medium such as a CD-ROM. It should be noted that this also applies to the other embodiment in this specification. Additionally, the software with which the moving object measuring apparatus according to this embodiment is implemented may be the following program. That is, this program is a program for letting a computer perform a movement trajectory information acquiring step of obtaining movement trajectory information indicating a movement trajectory of a moving object from images included in two or more video sequences that have been previously stored, for each of the two or more video sequences separately; a three-dimensional trajectory information acquiring step of obtaining, based on the movement trajectory information obtained by the movement trajectory information acquiring step for the two or more video sequences separately and two or more camera parameters that have been previously stored, three-dimensional trajectory information that is information of a three-dimensional trajectory of the moving object by using Visual Hulls Method; and a three-dimensional trajectory information output step of outputting the three-dimensional trajectory information.

Furthermore, in the above-described program, it is preferable that the movement trajectory information acquiring step extracts two or more pieces of movement trajectory information indicating a movement trajectory of the moving object from two or more images included in each of the previously stored two or more video sequences and combines the two or more pieces of movement trajectory information, thereby obtaining movement trajectory information corresponding to each of the video sequences.

### Embodiment 2

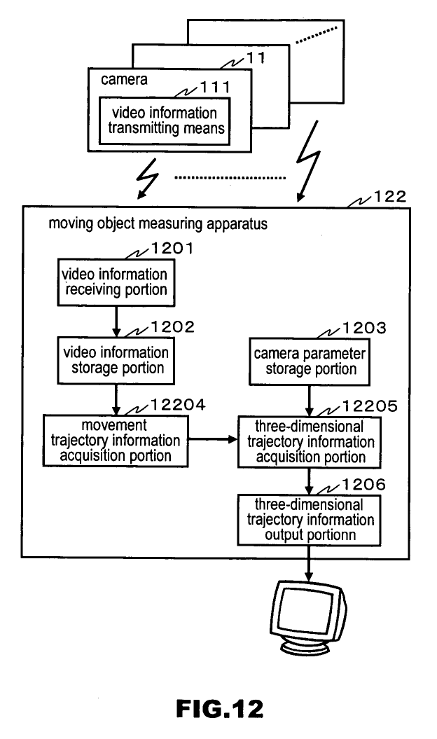

FIG. 12 is a block diagram showing a moving object measuring system according to this embodiment.

The moving object measuring system includes two or more cameras 11, and a moving object measuring apparatus 122.

The moving object measuring apparatus 122 includes a video information receiving portion 1201, a video information storage portion 1202, a camera parameter storage portion 1203, a movement trajectory information acquisition portion 12204, a three-dimensional trajectory information acquisition portion 12205 and a three-dimensional trajectory information output portion 1206.

The movement trajectory information acquisition portion 12204 obtains movement trajectory information indicating the movement trajectory of a moving object from images included in two or more video sequences stored in the video information storage portion 1202 for each of the two or more video sequences separately. Here, the movement trajectory information acquisition portion 12204 obtains movement trajectory information indicating the movement trajectory of the moving object from single images included in the two or more video sequences stored in the video information storage portion 1202 for each of the video sequences. In this case, it is necessary that the times at which the shutters are open for obtaining the images (still images) captured by the two or more cameras are overlapping, as shown in FIG. 11. Typically, the movement trajectory information acquisition portion 12204 may be implemented with an MPU, a memory or the like. The processing procedure of the movement trajectory information acquisition portion 12204 is typically implemented with software, which is recorded in a recording medium such as a ROM. However, the procedure may also be implemented with hardware (a dedicated circuit).

Based on the movement trajectory information obtained by the movement trajectory information acquisition portion 12204 for each of the two or more video sequences separately and the two or more camera parameters stored in the camera parameter storage portion 1203, the three-dimensional trajectory information acquisition portion 12205 obtains three-dimensional trajectory information that is information of the three-dimensional trajectory of the moving object by using Visual Hulls Method. Then, the three-dimensional trajectory information acquisition portion 12205 combines the obtained two or more pieces of three-dimensional trajectory information, thereby obtaining the three-dimensional trajectory information that is to be output. Typically, the three-dimensional trajectory information acquisition portion 12205 may be implemented with an MPU, a memory or the like. The processing procedure of the three-dimensional trajectory information acquisition portion 12205 is typically implemented with software, which is recorded in a recording medium such as a ROM.

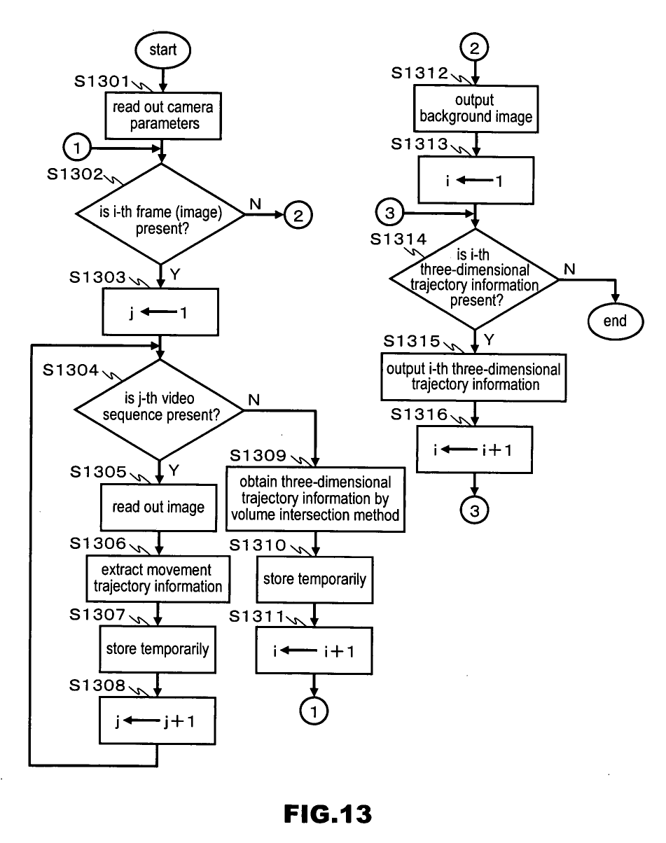

Next, the operation of the moving object measuring apparatus is described with reference to the flowchart shown in FIG. 13. It should be noted that in the flowchart of FIG. 13, the video information receiving portion 1201 receives two or more pieces of video information from two ore more cameras 11, and the received two or more pieces of video information are stored in the video information storage portion 1202.

(Step S1301) The three-dimensional trajectory information acquisition portion 12205 reads out the two or more camera parameters stored in the camera parameter storage portion 1203.

(Step S1302) The movement trajectory information acquisition portion 12204 judges whether the i-th frame (image) is present in all the video sequences stored in the video information storage portion 1202. If the i-th frame is present, then the procedure advances to Step S1303. If the i-th frame is not present, then the procedure advances to S1312. It should be noted that the two or more video sequences stored in the video information storage portion 1202 are video sequences that were started to be taken at substantially the same point of time and were captured for the same period of time.

(Step S1303) The movement trajectory information acquisition portion 12204 assigns 1 to the counter j.

(Step S1304) The movement trajectory information acquisition portion 12204 judges whether the j-th video sequence is present. If the j-th video sequence is present, then the procedure advances to Step S1305. If the j-th video sequence is not present, then the procedure advances to Step S1309:

(Step S1305) The movement trajectory information acquisition portion 12204 obtains the i-th frame (image) included in the j-th video sequence.

(Step S1306) The movement trajectory information acquisition portion 12204 obtains the movement trajectory information from the image obtained at Step S1304.

(Step S1307) The movement trajectory information acquisition portion 12204 temporarily stores, in a memory or the like, the movement trajectory information obtained at Step S1305.

(Step S1308) The movement trajectory information acquisition portion 12204 increments the counter j by 1. Then, the procedure returns to Step S1304.

(Step S1309) Based on the two or more camera parameters read out at Step S1301 and the two or more pieces of movement trajectory information temporarily stored at Step S1307, the three-dimensional trajectory information acquisition portion 12205 obtains three-dimensional trajectory information that is information of the three-dimensional trajectory of the moving object by using Visual Hulls Method.

(Step S1310) The three-dimensional trajectory information acquisition portion 12205 temporarily stores, in a memory or the like, the three-dimensional trajectory information obtained at Step S1309.

(Step S1311) The three-dimensional trajectory information acquisition portion 12205 increments the counter i by 1. Then, the procedure returns to Step S1302.

(Step S1312) The three-dimensional trajectory information output portion 1206 obtains a background image that has been previously stored, and outputs the background image. The background image may be, for example, an image of a table-tennis table.

(Step S1313) The three-dimensional trajectory information output portion 1206 assigns 1 to the counter i.

(Step S1314) The three-dimensional trajectory information output portion 1206 judges whether the i-th three-dimensional trajectory information is present. If the i-th three-dimensional trajectory information is present, then the procedure advances to Step S1315. If the i-th three-dimensional trajectory information is not present, then the process ends.

(Step S1315) The three-dimensional trajectory information output portion 1206 outputs the i-th three-dimensional trajectory information. The three-dimensional trajectory information output portion 1206 outputs the i-th three-dimensional trajectory information on the background image obtained at Step S1312.

(Step S1316) The three-dimensional trajectory information acquisition portion 12205 increments the counter i by 1. Then, the procedure returns to Step S1314.

The specific operation of the moving object measuring apparatus according to this embodiment is described below. A conceptual diagram of the moving object measuring apparatus is shown in FIG. 1.

Now, as shown in FIG. 4, the trajectory of a moving table-tennis ball is output using the moving object measuring system in the same manner as in the specific example described in Embodiment 1. That is, high-speed movements of the table-tennis ball are measured using the moving object measuring system.

The moving object measuring system of this embodiment includes three cameras 11 and a moving object measuring apparatus 12. The three cameras 11 are placed at the positions: (1) (0, −582, −154), (2) (−378, 257, −79), and (3) (−378, −9, −263). The camera of (1) is placed at a right angle to the side of the table-tennis table, the camera of (2) is placed obliquely to the side of the table-tennis table, and the camera of (3) is placed on the ceiling above the table-tennis table. In addition, the three cameras 11 are commercially available home video cameras whose shutter speed is set to 1/30 s, which is the same as the image-taking rate. Further, the size of images captured with the three cameras 11 is set to “720×480 (pixel)”.

Next, let us assume that the shapes of players playing table tennis are captured by the three cameras 11. Here, the captured images are stored in a recording medium (e.g., a hard disk or a magnetic tape).

Next, from the recording medium in which the video information that has been captured with the three cameras is recorded, the user copies the video information in the video information storage portion 1202 of the moving object measuring apparatus 12.

Further, the user sets camera parameters in the camera parameter storage portion 1203.

Next, the user gives an instruction to output the three-dimensional trajectory information (the trajectory of the moving table-tennis ball).

Next, the three-dimensional trajectory information acquisition portion 12205 reads out the necessary camera parameters from the camera parameter storage portion 1203. For example, here, the three-dimensional trajectory information acquisition portion 12205 reads out the three camera parameters: (1) (0, −582, −154), (2) (−378, 257, −79) and (3) (−378, −9, −263) stored in the camera parameter storage portion 1203. These camera parameters are pieces of the position information of the cameras.

Next, the movement trajectory information acquisition portion 12204 obtains the first image from the first video information in the video information storage portion 1202, and obtains the movement trajectory information by background subtraction. Next, the movement trajectory information acquisition portion 12204 obtains the first image from the second video information in the video information storage portion 1202, and obtains the movement trajectory information by background subtraction. Next, the movement trajectory information acquisition portion 12204 obtains the first image from the third video information in the video information storage portion 1202, and obtains the movement trajectory information by background subtraction.

Next, the three-dimensional trajectory information acquisition portion 12205 obtains the three-dimensional trajectory information that is information of the three-dimensional trajectory of the moving object by using Visual Hulls Method, using the above-described three pieces of movement trajectory information and three camera parameters. Typically, the three-dimensional trajectory information is a set of voxel information. In addition, this three-dimensional trajectory information is very short trajectory information.

Then, the movement trajectory information acquisition portion 12204 and the three-dimensional trajectory information acquisition portion 12205 repeatedly perform the above-described process for all the frames (images), thereby obtaining a large number of pieces of three-dimensional trajectory information (short trajectory information).

Next, the three-dimensional trajectory information output portion 1206 successively outputs the pieces of three-dimensional trajectory information obtained by the three-dimensional trajectory information acquisition portion 12205. An example of the three-dimensional trajectory information finally output by the three-dimensional trajectory information output portion 1206 is shown in FIG. 9.

As described above, according to this embodiment, it is possible to readily measure the continuous three-dimensional trajectories of a moving object (e.g., a ball). Moreover, it is also possible to determine a point at which a moving object bounced. Particularly, it is possible to measure the three-dimensional trajectory of a ball by simply placing several commonly used cameras whose shutter speeds are not high. Furthermore, it is not necessary to synchronize the shutters of the cameras, so that it is possible to readily measure the three-dimensional trajectory of a moving object.

It should be noted that the specific example of this embodiment is different from the above-described specific example of Embodiment 1 in the method for obtaining the movement trajectory information and the method (combining method) of the algorithm for obtaining the three-dimensional trajectory information. That is to say, the three-dimensional trajectory information acquisition portion of the moving object measuring apparatus may obtain the three-dimensional trajectory information for any amount (unit) at a time. Therefore, the moving object measuring apparatus of this embodiment may be a moving object measuring apparatus that obtains three-dimensional trajectory information that is information of a three-dimensional trajectory of a moving object by using Visual Hulls Method, based on movement trajectory information that is information indicating a movement trajectory of the moving object in images included in two or more video sequences that are two or more pieces of video information captured with two or more cameras placed at different positions in a space for capturing, at overlapping times, images of a moving object that moves in the space, the two or more video sequences including a plurality of images in which a movement trajectory of the moving object is retained, and outputs the three-dimensional trajectory information.

Furthermore, the software with which the moving object measuring apparatus according to this embodiment is implemented may be the following program. That is, this program is a program for letting a computer perform a movement trajectory information acquiring step of obtaining movement trajectory information indicating a movement trajectory of the moving object from images included in two or more video sequences that have been previously stored, for each of the two or more video sequences separately; a three-dimensional trajectory information acquiring step of obtaining three-dimensional trajectory information that is information of a three-dimensional trajectory of a moving object by using Visual Hulls Method, based on the movement trajectory information obtained by the movement trajectory information acquiring step for the two or more video sequences separately and two or more camera parameters that have been previously stored; and a three-dimensional trajectory information output step of outputting the three-dimensional trajectory information.

In the above-described program, it is preferable that the movement trajectory information acquiring step obtains movement trajectory information indicating a movement trajectory of the moving object from singles image included in the previously stored two or more video sequences, for each of the video sequences separately.

In each of the above-described embodiments, each process (each function) may be carried out by centralized processing using a single apparatus (system), or alternatively, may be carried out by distributed processing using a plurality of apparatuses.

The above-mentioned program may be executed by a single or a plurality of computers. In other words, the program may be performed by either centralized processing or distributed processing.

The present invention is not limited to the embodiments set forth herein. Various modifications are possible within the scope of the present invention

As described above, the moving object measuring apparatus according to the present invention has an effect such that the three-dimensional trajectory of a moving object can be readily measured, and is useful as, for example, an authoring system used for ball sports broadcasting and an authoring system for creating the content of a game or the like.

What is claimed is:

1. A moving object measuring apparatus comprising:
a video information storage portion storing two or more video sequences that are two or more pieces of video information captured with at least two cameras placed at different positions in a space for capturing, at overlapping times, images of a moving object that moves in the space, the two or more video sequences including a plurality of two-dimensional images in which a movement trajectory of the moving object is retained;
a camera parameter storage portion storing two or more camera parameters that are pieces of information relating to the two or more cameras;
a movement trajectory information acquisition portion that obtains movement trajectory information indicating a movement trajectory of the moving object from images included in the two or more video sequences stored in the video information storage portion, for each of the two or more video sequences separately;
a three-dimensional trajectory information acquisition portion that obtains three-dimensional trajectory information that is a three-dimensional trajectory of the moving object by using Visual Hulls Method, based on the movement trajectory information obtained by the movement trajectory information acquisition portion for each of the two or more video sequences separately and the two or more camera parameters stored in the camera parameter storage portion; and
a three-dimensional trajectory information output portion that outputs the three-dimensional trajectory information.

2. The moving object measuring apparatus according to claim 1,
wherein the two or more video sequences are captured with unsynchronized cameras.

3. The moving object measuring apparatus according to claim 2,
wherein the movement trajectory information acquisition portion extracts two or more pieces of movement trajectory information indicating a movement trajectory of the moving object from two or more images included in the two or more video sequences stored in the video information storage portion and combines the two or more pieces of movement trajectory information, thereby obtaining modified movement trajectory information corresponding to each of the video sequences.

4. The moving object measuring apparatus according to claim 2,
wherein the movement trajectory information acquisition portion obtains movement trajectory information indicating a movement trajectory of the moving object from single images included in the two or more video sequences stored in the video information storage portion, for each of the video sequences separately.

5. The moving object measuring apparatus according to claim 1,
wherein the video information is video information captured with a camera with 30 frames/sec.

6. The moving object measuring apparatus according to claim 3,
wherein the video information is video information captured with a camera with 30 frames/sec.

7. The moving object measuring apparatus according to claim 4,
wherein the video information is video information captured with a camera with 30 frames/sec.

8. A moving object measuring apparatus that obtains three-dimensional trajectory information that is information of a three-dimensional trajectory of a moving object by using Visual Hulls Method, based on movement trajectory information that is information indicating a movement trajectory of the moving object in images included in two or more video sequences that are two or more pieces of video information captured with two or more cameras placed at different positions in a space for capturing, at overlapping times, images of a moving object that moves in the space, the two or more video sequences including a plurality of images in which a movement trajectory of the moving object is retained, and outputs the three-dimensional trajectory information.

9. A moving object measuring system comprising:
two or more cameras that are placed at different positions in a space for capturing images of a moving object that moves in the space; and
the moving object measuring apparatus according to claim 1.

10. The moving object measuring system according to claim 9,
wherein the two or more cameras comprise a video information transmitting unit that transmits captured video information,
the moving object measuring apparatus further comprises a video information receiving portion that receives two or more pieces of video information from the two or more cameras, and
the two or more video sequences in the video information storage portion are the two or more pieces of video information received by the video information receiving portion.

11. A moving object measurement method comprising:
a movement trajectory information acquiring step of obtaining movement trajectory information indicating a movement trajectory of the moving object from images included in two or more video sequences that have been previously stored, for each of the two or more video sequences separately;
a three-dimensional trajectory information acquiring step of obtaining three-dimensional trajectory information that is information of a three-dimensional trajectory of the moving object by using Visual Hulls Method, based on the movement trajectory information obtained by the movement trajectory information acquiring step for each of the two or more video sequences separately and two or more camera parameters that have been previously stored; and
a three-dimensional trajectory information output step of outputting the three-dimensional trajectory information.

12. The moving object measurement method according to claim 11,
wherein the movement trajectory information acquiring step extracts two or more pieces of movement trajectory information indicating a movement trajectory of the moving object from two or more images included in the previously stored two or more video sequences and combines the two or more pieces of movement trajectory information, thereby obtaining movement trajectory information corresponding to each of the video sequences.

13. The moving object measurement method according to claim 11,
wherein the movement trajectory information acquiring step obtains movement trajectory information indicating a movement trajectory of the moving object from singles image included in the previously stored two or more video sequences, for each of the video sequences separately.

14. The moving object measurement method according to claim 11, further comprising
an image taking step of taking images of the moving object with two or more unsynchronized cameras, thereby obtaining two or more video sequences including a plurality of images in which a movement trajectory of the moving object is retained,
wherein the previously stored two or more video sequences are the two or more video sequences obtained in the image taking step.

15. The moving object measurement method according to claim 12, further comprising
an image taking step of taking images of the moving object with two or more unsynchronized cameras, thereby obtaining two or more video sequences including a plurality of images in which a movement trajectory of the moving object is retained,
wherein the previously stored two or more video sequences are the two or more video sequences obtained in the image taking step.

16. The moving object measurement method according to claim 13, further comprising
an image taking step of taking images of the moving object with two or more unsynchronized cameras, thereby obtaining two or more video sequences including a plurality of images in which a movement trajectory of the moving object is retained,
wherein the previously stored two or more video sequences are the two or more video sequences obtained in the image taking step.
